(19) United States
(12) Patent Application Publication
(10) Pub. No.: US 2025/0086479 A1
(43) Pub. Date: Mar. 13, 2025

(54) Method For Accurate Artificial Intelligence Classification and Detection Processes At An Edge

(71) Applicant: Tamir Rosenberg, Stevenson Ranch, CA (US)

(72) Inventor: Tamir Rosenberg, Stevenson Ranch, CA (US)

(21) Appl. No.: 18/464,659

(22) Filed: Sep. 11, 2023

Related U.S. Application Data
(60) Provisional application No. 63/405,761, filed on Sep. 12, 2022.

(51) Int. Cl. G06N 5/022

(52) U.S. Cl. CPC G06N 5/022

(57) ABSTRACT

Disclosed herein is a method for an accurate edge classification using artificial intelligence. The system includes a network and a plurality of terminal devices communicably coupled via the network. The plurality of terminal devices are configured to capture data. The system further includes microcontrollers communicably coupled to the plurality of terminal devices. The microcontrollers are configured to send data from the plurality of terminal devices to the microcontrollers via the network. The microcontrollers are further configured to classify the received data and predict the classified data via the microcontrollers using Artificial Intelligence (AI) algorithms. The microcontrollers are further configured to compare the prediction against a threshold using the microcontrollers, wherein if the prediction is below the threshold, nothing is detected, and if the prediction is within the threshold, data is transmitted to higher-level/compute AI algorithms running on server assembly, else when the prediction is higher than the threshold data is determined as accurate.

### CROSS-REFERENCE TO RELATED APPLICATION

This disclosure claims the benefit of the priority of U.S. Provisional Patent Application No. 63/405,761 entitled “Method for Accurate Artificial Intelligence Classification and Detection Processes at the Edge” and filed on 12 Sep. 2022. The above-identified application is incorporated herein by reference in its entirety.

### FIELD OF DISCLOSURE

The present disclosure relates generally to artificial intelligence. More specifically, relates to a method of edge classification for artificial intelligence.

### BACKGROUND OF THE DISCLOSURE

A microcontroller (MC) is an integrated circuit technology with numerous devices on a single chip that includes memory (RAM and ROM), I/O ports, timers/counters, communication interface, ADC, etc., and a CPU and/or GPU (processor). One of the first MCs was the Intel 8051 were initially designed using N-MOS technology, but the use of battery-powered systems and their low power consumption contribute to the use of CMOS technology (which is famous for its low power consumption).

While Intel built 8051 MCs (which was discontinued in 2007), 8051 compatible MCs began to be manufactured by more than 20 semiconductor manufacturers in the 1980s. Atmel (AT89C51, AT89S51), Phillips (S87C654), STC Micro (STC89C52), Infineon (SAB-C515, XC800), Siemens (SAB-C501), Silicon Labs (C8051), NXP (NXP700, NXP900), etc., are among the 8051 MCs generated by various manufacturers.

Today there are many forms of MCs available with a wide array of components and processing speeds and include Arduino, Raspberry Pi, Adafruit and Huzzah etc. Some inexpensive MCs can even run full-blown operating systems as well as AI algorithms.

Korean Patent No. KR2018006752A disclosed an edge system for AI, however it does not perform classification. United States Patent No.s US20200327371A1 and U.S. Pat. No. 10,007,513B2 disclosed edge systems for artificial intelligence (AI) however, they do not pass data on to larger systems for further interpretation.

As these low-cost computing devices become more available, what is needed is a cost-effective means to complement existing, resource-intensive hardware architecture when performing artificial intelligence (AI) recognition operations.

There is a need for a computing method of edge classification for artificial intelligence that solves the problems associated with the prior art.

### SUMMARY OF THE DISCLOSURE

The present disclosure discloses a method providing a solution to the shortcomings in the prior art through the disclosure of a low-end system upstream of existing, high-level, artificial intelligence (AI) systems.

The objective of the present disclosure is to minimize the use of network bandwidth and costly-servers during visual recognition operations and still get an accurate artificial intelligence (AI) classification and detection. Data transactions may even be written to a block chain.

The objective of the present disclosure is to reserve use of the high-level artificial intelligence (AI) systems for only complex analysis. By allowing low-power system to perform simple artificial intelligence (AI) tasks it can save on operating costs by only feeding complex artificial intelligence (AI) tasks to high-power computers when needed.

Another object of the invention is to provide a means to save on upfront costs.

Another object of the invention is to minimize costly network bandwidth. Many of today's leading AI providers only allow customers to access AI algorithms remotely on proprietary servers. The disclosed method may be operated locally on the plurality of microcontrollers at the edge (in situ) with local connections thereby removing remote applications all together and minimizing remote bandwidth.

Another object of the invention is to record all transactions on a decentralized ledger. All recordings and data events that are transmitted are hashed onto a smart contract and are made available in real time to all stakeholders on an immutable block chain. This feature ensures a high level of security and prevents data streams from being tampered with.

In light of the above, in one aspect of the present disclosure, a method for edge classification using artificial intelligence is disclosed herein. The system includes a network and a plurality of terminal devices communicably coupled via the network. The plurality of terminal devices is configured to capture data. The system further includes microcontrollers communicably coupled to the plurality of terminal devices. The microcontrollers are configured to send data from the plurality of terminal devices to the microcontrollers via the network. The microcontrollers are further configured to classify the received data via the microcontrollers. The microcontrollers are further configured to predict the classified data via the microcontrollers using Artificial Intelligence (AI) algorithms. The microcontrollers are further configured to compare the prediction against a threshold using the microcontrollers, when the prediction is lower than the threshold, data is transmitted to higher-level/compute AI algorithm running on a server assembly, else when the prediction is higher than the threshold data is accurate.

In an embodiment, a method for accurate artificial intelligence classification and detection is disclosed, the method comprising steps of capturing of data by a plurality of terminal devices, sending the data captured by the plurality of terminal devices to at least one edge device, classifying the received data by the at least one edge device, predicting the classified data using Artificial Intelligence (AI) algorithms, comparing the predicted classified data by the at least one edge device against a threshold, when the prediction is higher than the threshold, the AI classification and detection is successful; and wherein when the prediction is lower than the threshold, the data is transmitted to at least one higher-level/compute AI algorithm.

In one embodiment, data comprises images, videos, sounds, and so forth.

In one embodiment, the threshold is a predefined threshold defined by a user.

In one embodiment, the plurality of terminal devices comprises digital cameras, internet of things (IoT) devices, sensors, and so forth.

In one embodiment, the server assembly comprises at least one of servers, a cloud service, a blockchain, a decentralized ledger, a local storage, and so forth.

In an exemplary embodiment, a plurality of steps for accurate classification of complex data i.e. women and child are disclosed. The method comprises steps of capturing of the images using a CCTV camera and sending the images captured by the CCTV camera to a smart phone, wherein the microcontrollers of the smart phone classifies the images received by the CCTV camera and predicts the classified images using Artificial Intelligence (AI) algorithms, the micro controller compares the predicted classified images against a predefined threshold, wherein when the prediction is lower than the threshold, the images are further transmitted to at least one higher-level/compute AI algorithm, wherein the images are further analysed using a larger/stronger system/server/cloud service with a larger resources for another or more AI processes to get a high accuracy of images resulting into display of women and child.

In another exemplary embodiment, a plurality of steps for accurate classification of simple data i.e. a box is disclosed. The steps comprise capturing of the images using a CCTV camera and sending the images captured by the CCTV camera to a smart phone, wherein the microcontrollers of the smart phone classifies the images received by the CCTV camera and predicts the classified images using Artificial Intelligence (AI) algorithms, the micro controller compares the predicted classified images against a predefined threshold, when the prediction is higher than the threshold, the AI classification and detection becomes successful resulting into images shown as a box without sending the data to higher-level/compute AI algorithm.

In one embodiment, the decentralized ledger comprises blocks classified via a blockchain technique, when one of the pluralities of terminal devices sends data, a transaction is generated which is encrypted and added to a previous block selected from the blocks forming a hashed block chain.

In one embodiment, the transaction comprises a timestamp and metadata that is broadcast to authorized stakeholders as a recorded transaction and being available over the network.

In one embodiment, the network comprises a cloud network.

In one embodiment, the at least one edge device comprises a monitor, a display screen, a light-emitting diode (LED), an organic light-emitting diode (OLED), a laptop, any mobile device, and so forth.

In one embodiment, the microcontrollers are configured to determine captured data complexity with low-end artificial intelligence (AI) algorithms enabling classification, detection, prediction and sending signals directly to the at least output device.

In light of the above, in yet another aspect of the present disclosure, a method of edge classification for artificial intelligence is disclosed herein. The method includes sending data from a plurality of terminal devices to microcontrollers via a network. The method further includes classifying the received data via the microcontrollers. The method further includes predicting classified data via the microcontrollers using Artificial Intelligence (AI) algorithms. The method further includes comparing the prediction against a threshold using the microcontrollers, when the prediction is lower than the threshold, data is transmitted to higher-level/compute AI algorithm running on a server assembly, else when the prediction is higher than the threshold the method keep running and the data is accurate.

In one embodiment, data comprises images, videos, sounds, and so forth.

In one embodiment, the threshold is a predefined threshold defined by a user.

In one embodiment, the plurality of terminal devices comprises digital cameras, internet of things (IoT) devices, sensors, and so forth.

In one embodiment, the server assembly comprises at least one of servers, a cloud service, a blockchain, a decentralized ledger, a local storage, and so forth.

In one embodiment, the decentralized ledger comprises blocks classified via a blockchain technique, when one of the pluralities of terminal devices sends data, a transaction is generated which is encrypted and added to a previous block selected from the blocks forming a hashed block chain.

In one embodiment, the transaction comprises a timestamp and metadata that is broadcast to authorized stakeholders as a recorded transaction and being available over the network.

In one embodiment, the network comprises a cloud network.

In one embodiment, the at least one edge device comprises a monitor, a display screen, a light-emitting diode (LED), an organic light-emitting diode (OLED), a laptop, any mobile device, and so forth.

In one embodiment, the microcontrollers are configured to determine captured data complexity with low-end artificial intelligence (AI) algorithms enabling classification, detection, prediction and sending signals directly to the at least one edge device.

These elements, together with the other aspects of the present disclosure and various features are pointed out with particularity in the claims annexed hereto and form a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawing, in which:

FIG. 1 illustrates a perspective view of the inventive workflow of the computing system, in accordance with an exemplary embodiment of the present disclosure;

FIG. 2 illustrates other perspective view of the inventive workflow of the computing system, in accordance with an exemplary embodiment of the present disclosure;

FIG. 3 illustrates a representative view of the block chain workflow, in accordance with an exemplary embodiment of the present disclosure;

FIG. 4 illustrates a representative view of the classification and detection method, in accordance with an exemplary embodiment of the present disclosure; and

FIG. 5 illustrates a flow chart of a method of edge classification for artificial intelligence, in accordance with an exemplary embodiment of the present disclosure.

Like reference, numerals refer to like parts throughout the description of several views of the drawing.

### DETAILED DESCRIPTION OF THE DISCLOSURE

The following is a detailed description of embodiments of the disclosure depicted in the accompanying drawings. The embodiments are in such detail as to communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of the embodiments of the present disclosure. It may be apparent to one skilled in the art that embodiments of the present disclosure may be practiced without some of these specific details.

Various terms as used herein are shown below. To the extent a term is used, it should be given the broadest definition persons in the pertinent art have given that term as reflected in printed publications and issued patents at the time of filing.

The terms “a” and “an” herein do not denote a limitation of quantity, but rather denote the presence of at least one of the referenced items.

The terms “having”, “comprising”, “including”, and variations thereof signify the presence of a component.

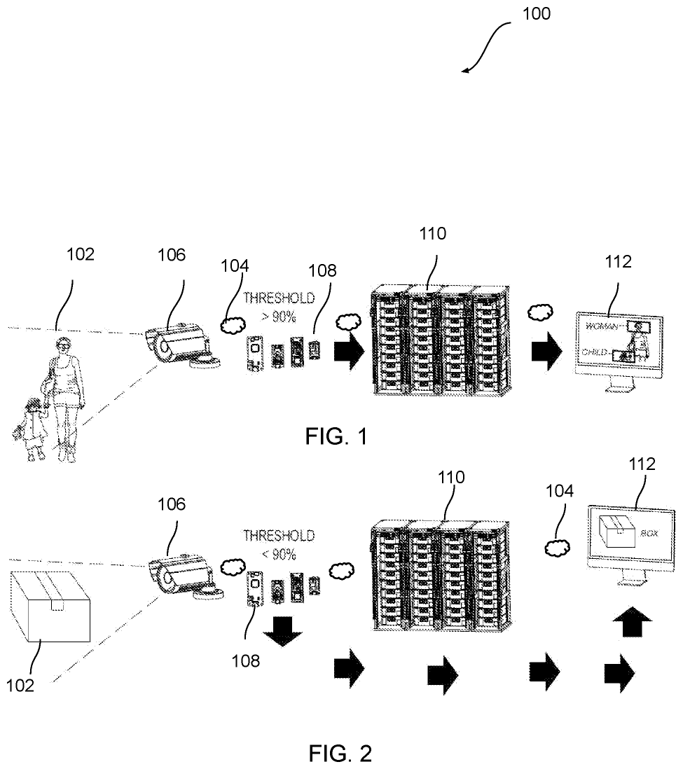

Referring now to FIG. 1 to FIG. 5 to describe various exemplary embodiments of the present disclosure. The system 100 of edge classification for artificial intelligence is disclosed. The system 100 includes a network 104, a plurality of terminal devices 106, microcontrollers 108 at the edge, a server assembly 110, at least one output 112, and so forth.

The network 104 may include a data network such as, but not limited to, an Internet, a Local Area Network (LAN), a Wide Area Network (WAN), a Metropolitan Area Network (MAN), and so forth. In some embodiments of the present invention, the network 104 may include a wireless network, such as, but not limited to, a cellular network and may employ various technologies including an Enhanced Data Rates for Global Evolution (EDGE), a General Packet Radio Service (GPRS), and so forth.

In some embodiments of the present invention, the network 104 may include or otherwise cover networks or sub-networks, each of which may include, for example, a wired or a wireless data pathway.

According to an embodiment of the present invention, the plurality of terminal devices 106, the microcontrollers 108 at the edge, the server assembly 110, and the at least one output device 112 may be configured to communicate with each other by one or more communication mediums connected to the network 104.

The communication mediums include, but are not limited to, a coaxial cable, a copper wire, a fiber optic, a wire that comprise a system bus coupled to a processor of a computing device, and so forth. Embodiments of the present invention are intended to include or otherwise cover any type of the communication mediums, including known, related art, and/or later developed technologies. The plurality of terminal devices 106 may be communicably coupled via the network 104. The plurality of terminal devices 106 may be configured to capture data. According to embodiments of the present disclosure, the plurality of terminal devices 106 may comprise digital cameras, internet of things (IoT) devices, sensors, and so forth.

In another embodiment, the plurality of terminal devices 106 may be configured to capture digital signals related to a plurality of objects.

The microcontrollers 108 at the edge may be communicably coupled to the plurality of terminal devices 106 via the network 104.

In one embodiment, the microcontrollers 108 at the edge may be configured to send data from the plurality of terminal devices 106 to the microcontrollers 108 at the edge via the network 104. The microcontrollers 108 at the edge may be further configured to classify the received data via the microcontrollers 108 at the edge. According to embodiments of the present disclosure, data comprises images, videos, sounds, and so forth.

The microcontrollers 108 at the edge may be further configured to predict the classified data via the microcontrollers 108 at the edge using Artificial Intelligence (AI) algorithms.

Referring to FIGS. 1 and 2, the microcontrollers 108 at the edge may be further configured to compare the prediction against a threshold using the microcontrollers 108 at the edge, when the prediction is lower than the threshold, data is transmitted to higher-level/compute AI algorithm running on the a server assembly 110, else when the prediction is higher than the threshold data passes data to the output device 112. In one embodiment, the threshold is a predefined threshold defined by a user.

The plurality of microcontrollers 108 at the edge may be a plurality of low-powered microcontrollers (MCs) having low-end AI capabilities, connected to plurality of terminal devices 106 at the edge, such as digital cameras and internet of things (IoT) devices in the field.

The plurality of microcontrollers 108 at the edge, may be configured to intercept digital signals and running artificial intelligence (AI) processes, before the digital signals are delivered to expensive, resource-intensive hardware servers (servers) or cloud services with high-end AI capabilities. Once intercepted, data which may be images are analyzed by the microcontrollers 108 at the edge, with low-end AI. Only if a recognition passes a needed threshold, the images are then passed on to the server assembly 110 which may include servers or to cloud services, for high-end level artificial intelligence (AI) processes.

Further, the microcontrollers 108 at the edge may be configured to determine captured data complexity with low-end artificial intelligence (AI) algorithms enabling classification, detection, prediction, and sending signals directly to the at least one output device 112.

In exemplary embodiment, low level AI algorithms determine whether or not the microcontrollers 108 at the edge may make an accurate detection and prediction based on a needed threshold. If results are passed the predefined threshold (which may be 90 percent), the output is passed on to high level server assembly 110 to perform the AI process with higher resources and then sent on to the network 104. The process repeats until data capture is complete.

According to embodiments of the present disclosure, the server assembly 110 may comprise at least one of servers, a cloud service, a blockchain, a decentralized ledger, a local storage, and so forth.

According to another embodiment of the present disclosure, the at least one output device 112 may be configured to display the plurality of objects that may be classified and predicted via the microcontrollers 108 at the edge over the network 104.

According to embodiments of the present disclosure, the at least one output device 112 may comprise a monitor, a display screen, a light-emitting diode (LED), an organic light-emitting diode (OLED), a laptop, any mobile device, and so forth.

According to embodiments of the present disclosure, the decentralized ledger comprises blocks classified via a blockchain technique, when one of the pluralities of terminal devices sends data, a transaction is generated which is encrypted and added to a previous block selected from the blocks forming a hashed block chain.

The transaction may comprise a timestamp and metadata that is broadcast to authorized stakeholders as a recorded transaction and being available over the network 102. In one embodiment, the network 102 may comprise a cloud network.

Conventional, resource-intensive, workstations are required to perform an accurate AI process (mainly for vision as well as other types of metadata) that have expensive CPUs, GPUs, and terabytes of memory. To minimize the use of such powerful computers, the current disclosure relies on much smaller computer resources called micro controllers (i.e., ESP32, STM32, etc.). These devices are sometimes used as IoT devices and are very cheap, use less power and can run lots of processes—including small/light/limited/low-end AI processes.

However, since the microcontrollers 108 at the edge have limited resources, their AI processes are limited and the accuracy is usually low, which sometimes limits accuracy and it's hard to make decisions based on these limited AI prediction/decision capabilities.

For example, in digital images, the plurality of microcontrollers 108 at the edge are better at classifying a single large object within a small resolution image of 96×96 when determining if an object is an apple or a banana, while larger servers included in the server assembly 110 are better at detecting a set of objects in a large frame area with larger resolutions of 1280×960 (example: differentiating lots of different people on a street). The microcontrollers 108 at the edge are much easier to use for AI classifications with low level detection processes, but less so for high accuracy detection processes.

The solution presented by the present disclosure herein sets the AI process at the edge to check the prediction using a classification/basic detection process (usually measured by threshold percentages) and only if the microcontrollers 108 at the edge findings pass some threshold (i.e., like >90%), only then the at least one edge device 112 may send or transmit the data which may be an image, a video or a sound to a larger, stronger system, server, cloud service with a larger resources for other AI processes to get a high accuracy of results.

Referring to FIG. 2, some industries do not require high-resolution artificial intelligence (AI) recognition systems to visually identify the plurality of objects which maybe boxes in manufacturing. In these instances, users may utilize the system 100 and method 500 with low-end AI recognition and save on upfront purchase costs. In one example, data of a box may be captured by the terminal device 106 which may be a camera and data is analyzed via the microcontrollers 108 at the edge.

In another example, a bottle assembly line needs to recognize stray bottle caps on the line. Rather than purchasing and installing a powerful, dedicated workstation to run expensive AI software to the area, they can simply install several, low-cost microcontrollers as part of the system to detect bottle caps.

The micro controllers 108 at the edge may includes but not limited to an Arduino, Raspberry Pi, ESP32, ESP8266 and the like embedded upstream of a conventional, remote, high-level, AI servers and downstream of the plurality of terminal devices 106 such as but not limited to digital camera (as shown in FIG. 1 and FIG. 2) or IoT device etc.

The microcontrollers 108 at the edge have the ability to determine input complexity with low-end AI algorithms enabled that may classify, detect and predict simple objects (such as a box) accurately and sending signals directly to a monitor as shown in FIG. 2.

When the microcontrollers 108 at the edge detecting complex objects that it's hard to detect, it classifies and or detect them as such and sends signals to the conventional, high level AI servers to detect and recognize and then sending to a monitor as shown in FIG. 1.

The plurality of terminal devices 106 may send sensor data and allow the microcontrollers 108 at the edge to detect and make predictions and trend analysis on simple data strings vs. sending complex data straight to the server assembly.

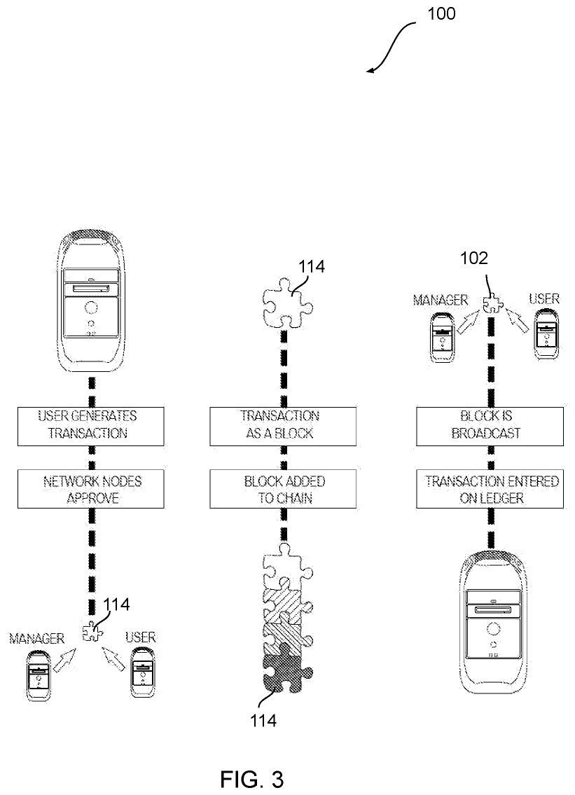

As seen in FIG. 3 shows the blockchain software that recognizes an initial data and classification transactions being registered as a genesis block after being approved by network nodes made up of but not limited to users, administrators and the like.

When the terminal device 106 (such as a camera or IoT device, etc.) sends data, a transaction being generated and encrypted and added to the previous block forming a hashed block chain wherein each transaction has a timestamp and metadata that is broadcast to said authorized stakeholders as a recorded transaction and being available only on the cloud network.

By design, the block chain resistant to modification of the data. For use as a distributed ledger 114, the block chain is typically managed by a peer-to-peer network, collectively adhering to a protocol for inter-node communication and validating new blocks. Once recorded, the data in any given block cannot be altered retroactively, without alteration of all subsequent blocks, which requires consensus of the network majority. Combined with smart contracts, such block chains can be considered as a decentralized notary service that allows for transparency so that anyone with pre-set privileges can see what is inside a data element record constructed using cryptographic hash and time stamped.

As used herein, “Smart contracts” are dynamic, live contracts that once created cannot be changed but can perform certain actions when certain conditions are met-such as sharing records automatically with pre-approved parties using digital signatures.

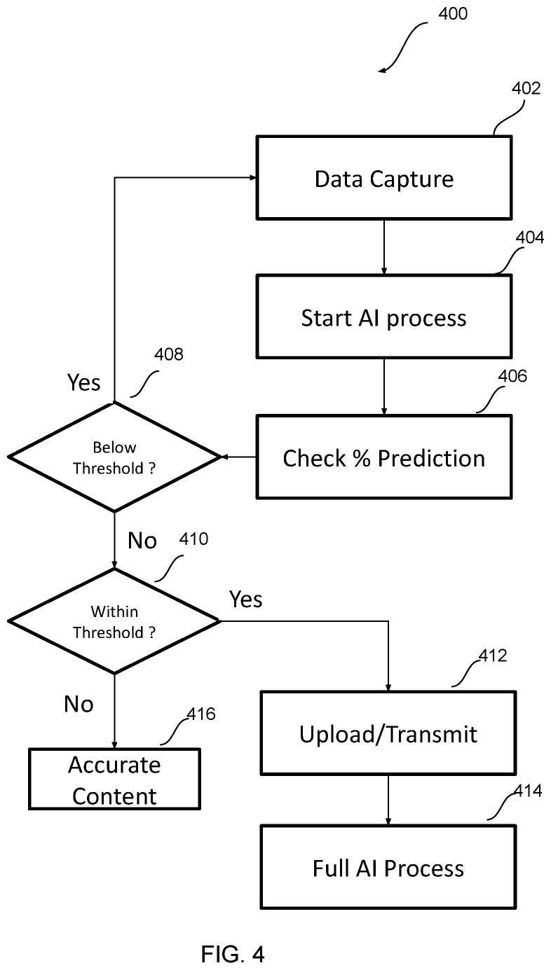

FIG. 4 illustrates a representative view of the classification and detection method, in accordance with an exemplary embodiment of the present disclosure. At 402, the plurality of terminal objects 106 may be configured to capture data of the plurality of objects 102.

At 404, the microcontrollers 108 at the edge may start the artificial intelligence processing to detect, classify and predict the edge.

At 406, when the prediction passes a predefined threshold (which may be 90 percent) at 408 and 410, then the data for high-end level artificial intelligence (AI) processes is transmitted to the server assembly 110 at 412 and the full artificial intelligence (AI) processes is completed at 414. Otherwise, the plurality of terminal objects 106 captures the data again. Moreover, if at 410, the prediction is above threshold, then the content is determined to be accurate 416.

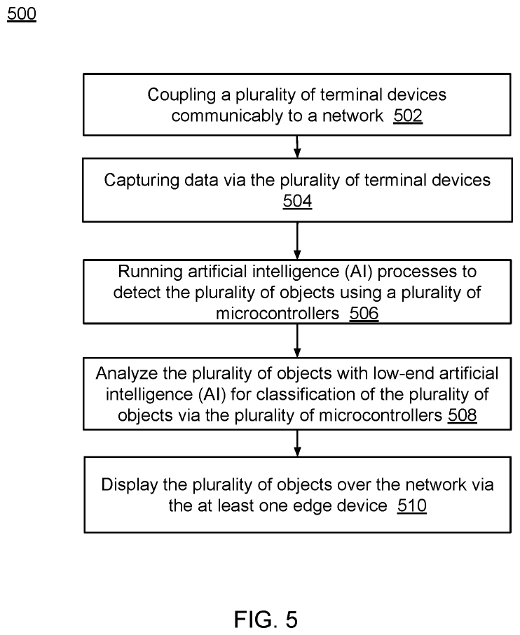

FIG. 5 illustrates a flow chart of a method 500 of edge classification for artificial intelligence, in accordance with an exemplary embodiment of the present disclosure.

At 502, sending data from the plurality of terminal devices 106 to microcontrollers 108 at the edge via the network 104. According to embodiments of the present disclosure, data comprises images, videos, sounds, and so forth. According to embodiments of the present disclosure, the plurality of terminal devices 106 may comprise digital cameras, internet of things (IoT) devices, sensors, and so forth.

At 504, capturing data via the plurality of terminal devices.

At 506, Running artificial intelligence (AI) processes to detect the plurality of objects using a plurality of microcontrollers. The microcontrollers 108 at the edge may be configured to determine captured data complexity with low-end artificial intelligence (AI) algorithms enabling classification, detection, prediction and sending signals directly to the at least one output device 112.

At 508, comparing the prediction against a threshold using the microcontrollers, when the prediction is lower than the threshold, data is transmitted to higher-level/compute AI algorithm running on a server assembly, else when the prediction is higher than the threshold the method 500 keep running. In one embodiment, the threshold may be a predefined threshold defined by a user. At 510, plurality of objects over the network are displayed via the at least one edge device

According to embodiments of the present disclosure, the server assembly 110 may comprise at least one of servers, a cloud service, blockchain, a decentralized ledger, a local storage, and so forth.

The decentralized ledger 114 comprises blocks classified via a blockchain technique, when the one of the pluralities of terminal devices 106 sends data, a transaction is generated which is encrypted and added to a previous block selected from the blocks forming a hashed block chain. The transaction may comprise a timestamp and metadata that is broadcast to an authorized stakeholders as a recorded transaction and being available over the network 104.

In some embodiments, the platforms, systems, media, and methods disclosed herein include software, server, cloud and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof.

In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The embodiments were chosen and described to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the present disclosure.

What is claimed is:

1. A method for accurate artificial intelligence classification and detection of content at an edge, the method comprising:
capturing a content by at least one terminal device at the edge;
sending the content to at least one microcontroller at the edge;
computing a prediction for the received content by the at least one microcontroller at the edge using at least one Artificial Intelligence (AI) algorithm;
comparing the prediction against at least one threshold, wherein the at least one threshold comprises at least a single value, and/or at least one range of values, or combination thereof;
wherein if the prediction is below the threshold, nothing is detected; and
wherein if the prediction is within the threshold, the detection of content is inaccurate and the content is sent to a higher-level AI process to get more accurate detection of the content; and
if the prediction is above the threshold, the detection of contents is accurate.

2. The method of claim 1, wherein the content comprises one or more images and/or videos and/or audio or any other digital files.

3. The method of claim 1, wherein the at least one terminal device comprises at least one input device including cameras, internet of things (IoT) devices, microphones, sensors, or combination thereof.

4. The method of claim 1, wherein the microcontroller is a low-powered microcontroller (MCs).

5. The method of claim 1, wherein the threshold is predefined.

6. The method of claim 1, wherein the threshold is user-defined.

7. The method of claim 1, wherein the at least one system with higher AI capabilities includes at least one computer, a computer assembly, cloud services or any combination thereof.

8. The method of claim 1, wherein a transaction is generated, and added to a blockchain database.
